(19) United States
(12) Patent Application Publication
(10) Pub. No.: US 2024/0198636 A1
(43) Pub. Date: Jun. 20, 2024

(54) VACUUM LIQUID RESIN LAMINATED GLASS PANEL AND METHODS FOR MAKING AND USING

(71) Applicant: SCIENSTRY, INC., Richardson, TX (US)

(72) Inventor: Jiansheng WANG, The Colony, TX (US)

(21) Appl. No.: 18/559,637

(22) PCT Filed: Apr. 18, 2023
(86) PCT No.: PCT/US2023/018925

§ 371 Date: Nov. 8, 2023

Related U.S. Application Data
(60) Provisional application No. 63/332,824, filed on Apr. 20, 2022.

(51) Int. Cl. B32B 17/10

(52) U.S. Cl. CPC B32B 17/10055; B32B 17/10201; B32B 17/10651; B32B 17/10678; B32B 17/10706; B32B 17/10917

(57) ABSTRACT

A liquid resin laminated glass panel includes: a first layer of glass, a second layer of glass, and a layer of polymer that is polymerized or cured from a liquid resin while in contact with the first layer of glass and the second layer of glass. The liquid resin is added into a substantially sealed glass cavity formed between the first layer of glass and the second layer of glass by a vacuum.

### CROSS-REFERENCE TO RELATED APPLICATION

This application claims priority to U.S. Provisional Patent Application No. 63/332,824 filed on Apr. 20, 2022, the disclosure of which is hereby incorporated by reference in its entirety.

### BACKGROUND

The present disclosure is generally directed toward methods for making laminated glass panels by vacuum filling a liquid resin into a glass cavity and curing the liquid resin.

Glass lamination is a process to create flat or curved compound glass products by pasting a thin glue layer between two or more pieces of glass sheet, then heating, pressing and bonding the glass sheets together. Glass lamination has been in existence for a long time. The most common methods used to make laminated glass are interlayer lamination or autoclave lamination and cast lamination. The common interlayers used for autoclave lamination are thermoplastic materials of polyvinyl butyral (PVB), ethylene-vinyl acetate (EVA), and thermoplastic (TPU). The common liquid resins used for cast lamination are UV curable polyurethane.

There exists a need for improved technologies for producing laminated glass, including reduced cost, and better quality, toughness, stiffness, wider temperature range, and using more types of polymers. These functions are achieved with an improved vacuum liquid resin lamination (VLRL), discussed below.

Glass lamination is a common process to make glass panels more durable and safer. Lamination with an interlayer of a thermoplastic sheet is a common method of making laminated glass. Bent or tempered glass is normally difficult to be used in interlayer lamination, because the bent or tempered glass lacks the required flatness. Furthermore, most polymers formed by two or more parts are not suitable for cast lamination, because of the difficulties associated with removing fine air bubbles after mixing all of the parts together, as discussed below.

### SUMMARY

The embodiments of the disclosure are listed by the claims that follow the description.

A panel apparatus comprises a glass layer and an interlayer polymerized from a liquid resin within the panel. A vacuum liquid resin lamination (VLRL) method of making the apparatus is disclosed. In some embodiments, low compressed air pressure may be applied to accelerate processing speed.

In some embodiments of the panel apparatus, the liquid resin is added into a substantially sealed glass cavity with a degassing.

In some embodiments of the panel apparatus, the layer of polymer is formed from a one-part resin or a multiple-part resin.

In some embodiments of the panel apparatus, the polymer or the liquid resin comprises spacers.

In some embodiments of the panel apparatus, the layer of polymer comprises one or more of: a polyacrylate, a polyurethane, a polycarbonate, a polysilicon, a polyester, an epoxy, a polysulfide, a polyimide, polyphenolic, a polyethylene or a copolymer.

In some embodiments of the panel apparatus, the polymer or the liquid resin further comprises one or more of: a dye(s), a pigment(s), a coupling agent(s) and/or an UV absorber(s).

In some embodiments of the panel apparatus, the layer of glass comprises a low-e coating.

In some embodiments of the panel apparatus, the layer of polymer comprises an insert with different materials including natural carbohydrate, paper, picture, or plastic sheet for different purposes including decoration or reinforcement.

In some embodiments of the panel apparatus, e two layers of glass are separated with a sealing spacer positioned at edges of the layers of glass, thereby defining a gap between the two layers of glass, to form a laminated insulating glass unit.

In some embodiments of the panel apparatus, the gap is filled with air or an inert gas, or is a vacuum.

A method for making a liquid resin laminated glass panel includes: providing a glass cavity, wherein the glass cavity comprises a first layer of glass and a second layer of glass, the glass cavity subsequently being substantially sealed at edges; placing a liquid resin between the first layer of glass and the second layer of glass; and curing the liquid resin to form the panel. In some implementations of the method, the liquid resin is added into the glass cavity by a vacuum and subsequently cured to bond to the first layer of glass and the second layer of glass.

In some embodiments of the method, the glass cavity is sealed with tape.

In some embodiments of the method, the first layer of glass and the second layer of glass are separated by spacers when being bonded.

In some embodiments, the method further comprises creating an opening on the edges of the glass cavity and attaching an adaptor attached to the opening to allow air or the liquid resin to enter or leave the glass cavity.

In some embodiments of the method, before or during filling the glass cavity with the liquid resin, the liquid resin is degassed.

In some embodiments of the method, the liquid resin is cured by exposing the liquid resin to daylight, ultraviolet light or heat.

In some embodiments of the method, placing the liquid resin comprises a use of compressed air to increase a filling rate and/or prevent formation of vacuum spot(s).

In some embodiments of the method, the panel is fitted to a third layer of glass positioned on the panel such that the third layer of glass is separated from the panel with a sealing spacer positioned at edges thereof, thereby defining a gap between the panel and the third layer of glass. A system for making a liquid resin laminated glass panel includes: a glass cavity substantially sealed at edges configured to be filled with a liquid resin under a vacuum; an adaptor attached to the glass cavity to transfer the liquid resin or air into or out of the glass cavity; a vacuum pump for filling degassing the liquid resin or filling the liquid resin into the glass cavity; a container to hold the liquid resin for filling up the glass cavity or to collect the liquid resin from the glass cavity; and a valve connecting the adaptor and the container to control the liquid resin and/or air passing through.

Additional aspects, features, functions, and advantages of the present disclosure will become apparent from the following detailed description.

### BRIEF DESCRIPTION OF THE DRAWINGS

FIG. 1 shows a cross-sectional view of a conventional laminated glass panel.

FIG. 2 shows a cross-sectional view of an example of an improved vacuum resin laminated glass panel according to one or more embodiments of the present disclosure.

FIG. 3A shows a front view of an example of a glass cavity for forming a vacuum liquid resin laminated glass (VLRLG) panel apparatus according to one or more embodiments of the present disclosure.

FIG. 3B shows a front view of another example of a glass cavity for forming a vacuum liquid resin laminated glass (VLRLG) panel apparatus according to one or more embodiments of the present disclosure.

FIG. 4 illustrates an example of a vacuum liquid resin lamination system apparatus for filling single-part resin according to one or more embodiments of the present disclosure.

FIG. 5 illustrates an example of a vacuum liquid resin lamination (VLRL) system for filling a multi-part resin according to one or more embodiments of the present disclosure.

FIG. 6 shows a cross-sectional view of laminated insulating glass unit (IGU) according to one or more embodiments of the present disclosure.

### DETAILED DESCRIPTIONS

The following disclosure provides many different embodiments, or examples, for implementing different features of the disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Laminated glass (LG) is a type of safety glass that holds together when shattered. In the event of breaking, it is held in place by a thin polymer interlayer. The methods and processes for making laminated glass have been used for a long time. However, the requirements of modern industry are constantly changing, requiring improved properties in laminated glass, such as greater toughness and stiffness, wider temperature range and lower manufacturing costs. However, the conventional method and process of glass lamination have their limitations, including requiring large equipment, high energy consumption, a relatively long process time, and limited suitable polymers. Consequently, meeting the requirements of modern industry with these existing limitations is challenging.

For better durability and safety, glass is often laminated into two or more pieces of glass by using interlayer, which is a soft film material which may have an adhesion function when melted at a high temperature. An interlayer is a thermoplastic material that may be used to bond glass or plastic together through a high-temperature process, called interlayer lamination. Sometimes, both the interlayer material and the interlayer film prior to use in lamination and the internal layer formed from the interlayer material after a lamination process are called “interlayer” in the glass industry.

As used herein, “liquid resin lamination” can refer to a lamination process using liquid resin added into the space between two pieces of glass resulting in seamless laminated glass “Cast lamination” refers to a lamination process using liquid resin added by gravity into the space between two pieces of glass resulting in seamless laminated glass “Vacuum liquid resin lamination” (VLRL) refers to a lamination process using liquid resin added by vacuum into the space between two pieces of glass resulting in seamless laminated glass.

As used herein, “glass” can refer to conventional silica-based glass as well as polymer-based transparent materials, such as acrylic glass and polycarbonate glass, which have a relatively rigid planar or curved format. Glass may be colored or include tinting. Glass may also include annealed, reinforced, toughened and/or laminated glasses or any other type of transparent material having higher strength, safety or other special features, such as self-cleaning. Glass may also have an anti-reflective coating or anti-glare coatings. The aforementioned types of glass may also have a low-e coating.

As used herein, “liquid resin” means a liquid resin that may be polymerized to form a solid. Liquid resin includes various types of resins, such as acrylic resin, methacrylate resin, urethane resin, silicone resin, polyester resin, epoxy resin, and polysulfide resin.

As used herein, a “multi-part resin” is a type of resin that consists of two or more separate parts that must be mixed together in order to activate the curing process.

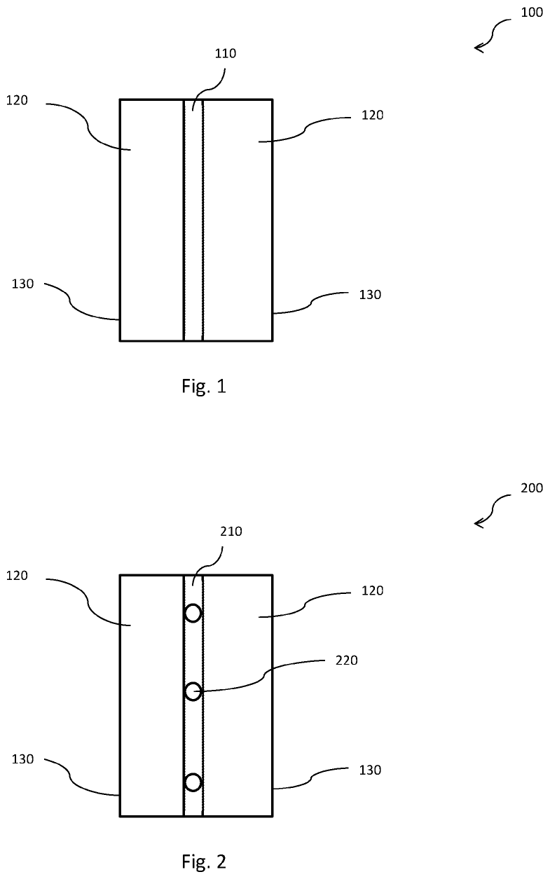

Referring to FIG. 1, a cross-sectional view of an example of conventionally laminated glass 100 is illustrated. The structure of conventionally laminated glass 100 includes glass 120 with a glass surface 130 and a layer of interlayer 110. Although interlayer 110 is used in this discussion, it should be understood that the interlayer 110 is a thermoplastic material, such as polyvinyl butyral (PVB), ethylene vinyl acetate (EVA), and/or thermoplastic polyurethane (TPU).

Referring to FIG. 2, a cross-sectional view of an example of improved vacuum liquid resin laminated glass 200 is shown. The structure of the vacuum liquid resin laminated glass 200 includes glass 120 with glass surface 130 and an improved interlayer 210. It should be noted that there is a great difference between interlayer 110 of the conventionally laminated glass 100 with reference to FIG. 1 and interlayer 210 in this example. Specifically, the interlayer 110 usually is a polymer made of thermoplastic materials, such as polyvinyl butyral (PVB), ethylene vinyl acetate (EVA), and/or thermoplastic polyurethane (TPU). In contrast, the interlayer 210 is a polymer or copolymer material filled under a vacuum and directly polymerized from a resin of monomers or oligomers that come into contact with the glass 120. Depending on the size of the panel to be manufactured, in some implementations, the laminated glass 200 can contain spacers 220 in the interlayer 210 to precisely control the thickness of the interlayer 210. There is no need to add spacers for making small sizes of the glass panel or for a case wherein the thickness of the interlayer is not critical, as discussed herein.

Cast lamination with liquid resin is another lamination process used in the industry. In the conventional process for cast lamination, a glass cavity is created from two pieces of glass with sealed edges, and a liquid resin is filled from the top edge by gravity. This specification provides an improved process for producing vacuum liquid resin laminated glass. To make a laminated glass using this method of producing vacuum liquid resin laminated glass 200, a glass cavity 300 is also necessary, as discussed below.

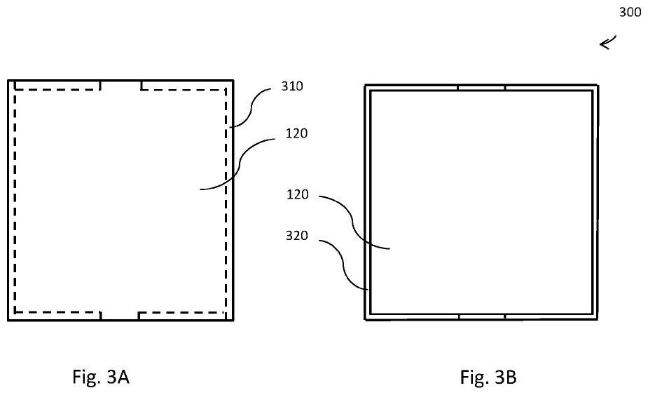

FIG. 3A and FIG. 3B are front views of examples of glass cavity 300. In both examples, the class cavity 300 is formed by two glass layers and sealed with tapes. FIG. 3A illustrates a glass cavity with double-sided tape 310 placed at all edges of the cavity 300. In this embodiment, the thickness of the cavity is determined by the thickness of the double-sided tape 310. The double-sided tape 310 is placed inside of glass edges in between two layers of glass, and the tape 310 usually remains in the final product. For larger glass cavities, spacers (not shown) may be sprayed on the inner surface of one (first) layer of glass before applying the double-sided tape 310. After removing the spaces at all edges by wiping, double-sided tape 310 may be placed at the edges before making (cut) two openings at the top and bottom of the first layer, and then the second layer of glass is added on top of the first layer of glass to form a cavity. The thickness of the double-sided tape 310 or the diameter of spacers may be between 0.015 to 0.03 inch (0.38 to 0.76 millimeter), which is equivalent to one to two layers of interlayer, like PVB interlayer with a thickness of 0.015 inch (0.381 mm). Since liquid resins are relatively inexpensive, the thickness of the cavity can be increased. Spacers 220 (shown in FIG. 2) can be used to precisely control the thickness of interlayer 210 between the two glass layers with sizes ranging from 10 microns to 1 mm. If making small sizes of the laminated glass 200, spacers are not necessary, as the double-sided tape 310 and rigidity of glass 120 may retain a proper thickness of the cavity 300. Furthermore, in some applications, the thickness of the interlayer may not be critical. On the other hand, when making a laminated glass with a specific feature, such as bullet-proof glass, the controllable thickness of interlayer by the tape and spacer and easily selected properties is an advantage, because anti-impact capability depends on the type and the thickness of interlayer material used and type of thickness of glass used. A calculation can be used to determine what type of material and strength and layer thickness is needed to meet the required features. Furthermore, as will be described below, the flexibility of the VLRL technology is very helpful for reaching such goals.

FIG. 3B illustrates a glass cavity with a single-sided tape 320. The single-sided tape 320 is placed on the outside of all of the edges of the glass panel, and the tape 320 can be removed from the final product. If using a wider tape 320, the top and bottom surfaces at edges can be also covered.

In cast lamination, the top edge or a portion of the top edge is not sealed before adding a liquid resin into a cavity similar to cavity 300. A liquid resin is poured into the cavity from the unsealed top edge by gravity. When the resin level is close to the top edge, resin addition stops. The entrapped air is essentially squeezed out before sealing the top edge. However, some air is still trapped in the cavity, and adding the liquid resin into the cavity generates small air bubbles. The air and small air bubbles must then be removed with a syringe equipped with a long needle.

Since all processes of cast lamination are carried out under atmospheric pressure (i.e., the pressure inside the cavity is the same as the pressure in the environment), making it difficult to remove small air bubbles from the resin before curing. These air bubbles can create defects if not completely removed from the cavity. Removing small air bubbles from a large-sized glass cavity is challenging, because a long syringe needle cannot precisely point to small bubbles from a relatively far distance. Therefore, the size of products produced by cast lamination has practical limitations. Since the air bubbles are difficult to be removed in cast lamination, only UV curable resin can be used because this type of resin does not need to be mixed right before use, meaning that there is enough time to naturally remove air bubbles by a long-time setting. However, in order to use resins with two or more components, such as a monomer or oligomer and a curing agent, a mixing process is necessary and the mixing process generates a lot of small bubbles which are difficult to be removed within the limited working time before the resin gels. Thus, cast lamination is not suitable for using two or more-part resins; however, most polymers are formed of two or more parts. Moreover, the exothermic process of UV curing generates heat in a UV curable resin, causing “vacuum spots” or “vacuum bubbles” generated by material shrinkage in the cavity when the laminated glass is cooled down after UV curing. Most liquid resins shrink in volume or increase in density when they are cured, or change from a liquid state to a solid state, or cool from high temperature. A large shrinkage may cause ““vacuum spots” or “vacuum bubbles”. Such challenges often reduce yield and increase process time and cost in cast lamination processes. Despite being invented for many years, cast lamination has not been widely used in the industry.

This specification provides an improved material system and method, called vacuum liquid resin lamination (VLRL), to effectively overcome the issues and challenges mentioned above with cast lamination and interlayer lamination.

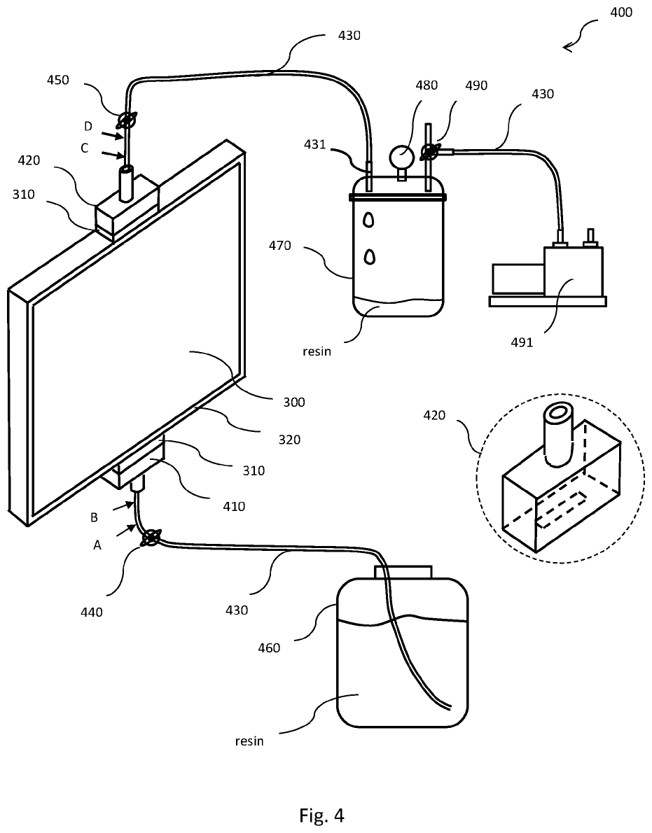

FIG. 4 illustrates a system 400 for performing vacuum liquid resin lamination (VLRL). The system 400 includes a glass cavity 300 connected to an inlet adaptor 410 and an outlet adaptor 420. An enlarged isometric view of outlet adaptor 420 is provided for detail. The adaptors 410 and 420 are attached to the cavity 300 with a double-sided tape 310 or glue layer such as silicone glue. The adaptors 410 and 420 can have the same design, being made of materials like plastic or metal such as aluminum. The adaptors 410 and 420 are connected with a soft tubing 430. A valve 440 is situated close to the inlet adaptor 410 and a valve 450 is situated close to the outlet adaptor 420. The inlet adaptor 410 is connected to a resin container 460 through soft tubing 430 and short rigid tubing 431. The outlet adaptor 420 is connected to an air-liquid separator 470 acting as a receiving container. The receiving container 470 is equipped with a vacuum and pressure meter 480 and is connected to a vacuum pump 491 and to the atmosphere through a 3-way valve 490.

In some implementations, to make a vacuum liquid resin laminated glass, using the VLRL system 400, a process including the following operational steps (A1)-(A5) can be performed.

(A1) Prepare a glass cavity 300. Hand clean or machine clean two pieces of glass. Put one (first) piece of glass on a table or tilt table, and spray a mixture of spacers and isopropyl alcohol (99%) on surface of the first piece of glass. If trying to make a glass cavity shown in FIG. 3A, use a cleanroom wipe to remove spacers in all edges, and then put double-sided tape 310 in the edges and make openings as shown in FIG. 3A, put the second piece of glass on the top of the first piece of glass to form a glass cavity 300 with two openings on top and bottom (opening positions may be changed). If trying to make a glass cavity 300 shown in FIG. 3B, after spraying spacers, no need to remove spacers in the edges, put the second piece of glass on the top of the first piece of glass. Use a single-sided tape 320 to seal all edges to form a glass cavity, and then use a sharp blade to make two openings on top and bottom of the sealed panel by removing some of the tape 320.

(A2) Assembling the VLRL system 400. Attach adaptors 410 and 420 to the cavity 300 (the adaptor 410 and 420 may be the same design with double-sided tape and liner for one time use or with glue layer such as silicone glue). Make sure that the cavity 300 is set in an essentially vertical position, so that air in unfilled space in cavity 300 can be pushed out by filled liquid resin, and make sure there is enough resin in resin container 460, and that receiving container 470 is almost empty, and all parts are connected as shown in FIG. 4, and the 3-way valve 490 is in a position connecting to the atmosphere.

(A3) Test leakage of the system 400. Set valve 440 in a “close” position, and valve 450 is in a “open” position. Turn 3-way valve 490 to a position to connect receiving container 470 and vacuum pump 491 and turn on the vacuum pump 491. If the vacuum and pressure meter 480 shows a vacuum level close to the maximum vacuum level of the vacuum pump 491 and the vacuum level is held for a few minutes after turning off vacuum pump 491, it means that the system is well sealed and ready for filling the resin; otherwise, need to check and fix leaks and repeat this process.

(A4) Conduct a vacuum liquid resin lamination. Make sure vacuum pump 491 is on. Slowly turn valve 440 to an “open” position and allow the resin to be filled into the cavity 300. When filled resin just comes out from the bottom of the cavity 300, turn off valve 440 for a moment to allow possible air bubbles in this first portion of the resin to be removed by vacuum, and then open valve 440 to continue filling. The valve 440 may have two functions, including providing degassing function and supplying resin. When no supply of resin or resin supply is limited by the valve 440, a degassing function occurs in the cavity 300. When the resin reaches the top edge of the cavity 300, continue to fill the panel and allow extra resin to be collected in the receiving container 470. If no bubbles remain in the filled cavity 300, turn off the valve 450 and vacuum pump 491, and then turn 3-way valve 490 to an “atmosphere” position. Wait for about 1 minute to allow the filled cavity to be in a pressure-balanced state by continuously sucking more resin into the cavity, and then turn off valve 440. Now, the cavity 300 is fully filled with the resin. In case of that there are some bubbles remained in the upper corners of cavity 300, the filling process may be partially repeated by turning 3-way valve 490 to a position connecting to the receiving container 470 and atmosphere, and allow a level of filled resin to be dropped a little, and then turn the 3-way valve back to the position connecting to the receiving container 470 and vacuum pump 491 and resume a vacuum. Since the repeating step is so simple, it is easy to fill the cavity free of air bubbles. Put pipe clamps in positions A and B and cut the hose between positions A and B. Put pipe clamps in positions C and D and cut the hose between positions C and D. Remove the filled panel from the VLRL system 400 and then subject the filled panel to the curing process. In many cases, the collected resin in the receiving container 470 may be reused with or without a filtration.

As can be seen, in some embodiments, the tubing is cut at a position close to the glass panel. The reason to close the glass panel is for easy operation and for saving resin, because after cutting the tubing, the next step is to move the filled panel to the curing area.

(A5) Curing resin. Depending on what kind of resin is used, the filled panel may be cured using different curing conditions. For example, if a UV curable resin, such as acrylate, methacrylate, UV curable polyurethane, UV curable silicone or dual (UV and heat) curing resin, is used, the filled panel may go through a UV exposure system to cure the resin or be cured with UV chandeliers for large area irradiation. If a room temperature curing resin, such as epoxy resin or silicone resin, is used, the filled panel may be set at room temperature for curing. If a thermoset resin, such as epoxy resin, is used, the filled panel may go through thermo-curing equipment, such as a reflow oven or walk-in oven or a room like a sauna room with increased temperature, for curing. After curing, the product, vacuum liquid resin laminated glass (VLRLG), is produced by detaching the adaptors 410 and 420 and/or tape 320. It is necessary to note that most UV curable resins are light sensitive and UV curable resins are normally stored in a light-tight container. If the UV curable resin near the openings of the cavity is cured by a hand-held UV light, the panel filled with UV curable resin may be also cured by a setting in a bright area with natural lights, but may need a relatively longer curing time than curing time with a UV exposure system. A slow curing is favorable to prevent the appearance of vacuum spots due to polymer shrinkage.

One key difference between the conventional methods and the methods described herein is that the conventional methods use a low vacuum before and during filling and the vacuum is only a force to draw resin in the conventional methods. In contrast, the method described herein performs a degassing function with a high vacuum before and during filling, plus a function of drawing resin. The “low vacuum” and “high vacuum” used herein are industrial and qualitative terms, mainly relative to the atmospheric pressure. One atmosphere pressure is equal to 760 millimeters of mercury. A vacuum close to 760 mm Hg is called a low vacuum, and a vacuum close to 0 mm Hg is called a high vacuum. A glass cavity under a high vacuum may be close to a true vacuum or 0 mm Hg, in which most of air has been removed. Therefore, it is almost impossible to form an air bubble(s) in the liquid resin layer of the glass cavity.

As discussed herein, a high vacuum has a strong driving force for filling; therefore, it may handle higher viscosities and/or have higher filling speeds. Also, the degassing method has much higher tolerance for dirty glass surfaces. Finally, it is very difficult to form a vacuum spot, as adding pressure will easily destroy any vacuum spot.

As will be apparent to those of skill in the art, in some embodiments, the VLRL system 400 comprises simple components and can be easily operated by small companies to do glass lamination without large equipment. The method overcomes a long-lasting problem of preventing and/or removing small bubbles from the filled cavity, especially when making a large panel. That is, while even the autoclave method and the vacuum oven method have limitations for maximum glass panel size, the VLRL method does not have a limitation for the panel size. Furthermore, in cast lamination, it is time-consuming work to find and remove small bubbles in the filled resin. In contrast, the VLRL provides much more reliable results and defect-free products.

As noted above, the exemplary operational and/or experimental procedure described above has an advantage in that all parts including pump 491 and air-liquid separator or receiving container 470 are inexpensive parts of laboratory devices. For example, a laboratory vacuum triangle flask may be used as the receiving container, and even a hand operated pump may be used for such a process. Since working spaces for vacuum are very small for VLRL process, a small vacuum pump may meet the job. However, if using a two-part resin system, which has a working time, or a time period of which a mixture remains fluid after mixing resin with a curing agent, usually can't be reused. Therefore, collected resin in receiving container 470 will be wasted. The filling situation may be improved with a high-performance vacuum pump such as a two-stage vacuum pump. The two-stage vacuum pump may reach a high vacuum of 20-40 microns of mercury. Under such a high vacuum, air will enlarge its volume over 25000 times, or a bean sized bubble under 20-40 microns vacuum will be shrunk 25000 times smaller under atmosphere pressure, and such a shrunken air bubble under atmosphere pressure is invisible to human eyes, and such small air bubble may also be easily dissolved into the liquid resin.

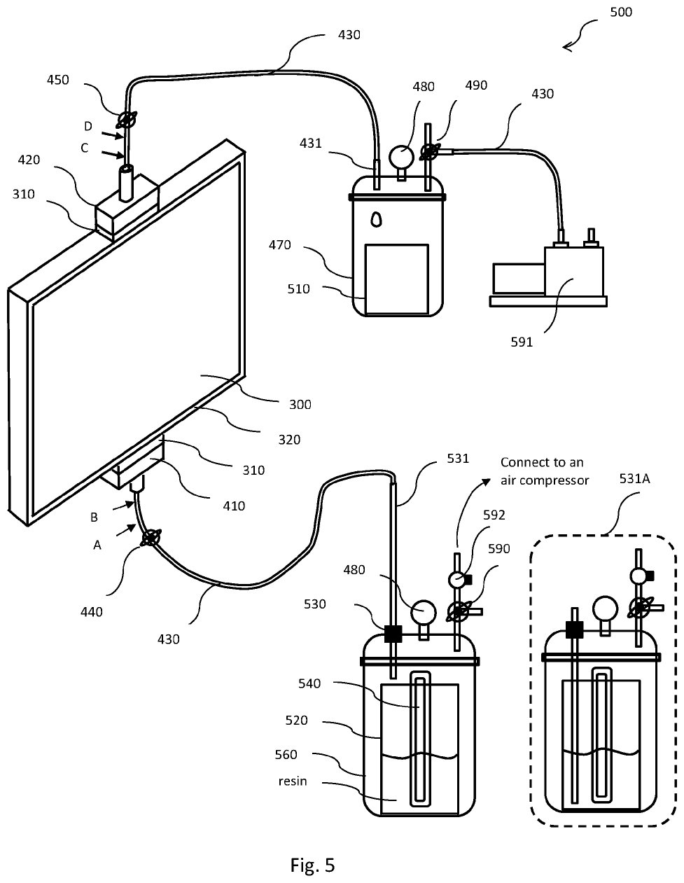

FIG. 5 illustrates a VLRL system 500 for filling a multi-part resin. In some implementations, to make a vacuum liquid resin laminated glass using the VLRL system 500, a process including the following operational steps (B1)-(B6) can be performed.

As an operational or experimental procedure, FIG. 5 and the following operational steps show additional advantages of using the VLRL system apparatus 500 to make a vacuum liquid resin laminated glass and to better handle multi-parts resin:

(B1) Preparing a glass cavity 300 is the same as the procedure (A1) for system 400 described above.

(B2) Assembling the VLRL system 500 is similar to the procedure (A2) for system 400 described above, but the system 500 includes different devices as shown in FIG. 5. In this embodiment, attach adaptors 410 and 420 to the cavity 300. The cavity 300 may be set in essentially a vertical position. The inlet adaptor 410 is connected to resin supply container 560 through soft tubing 430 and long rigid tubing 531. Resin supply container 560 has a similar structure to the receiving container 470, except that it has a window 540 and rubber seal ring 530. Long rigid tubing 531 may be slid up to above the surface of the resin or be slid down into the resin. There is a clear container 520 with resin put in resin supply container 560. Place a disposable receiving container 510 inside of the receiving container 470, because the multiple part resin will be cured after mixing. A high-performance vacuum pump 591 such as a two-stage vacuum pump is used for VLRL system apparatus 500. The 3-way valve 490 is set at a position connecting to the atmosphere.

(B3) Resin preparation. Unlike a one-part resin, all components of a resin having two or more parts need to be mixed right before use. Add required parts into a (plastic or glass) clear container 520. Resin level may be about half of the height of clear container 520 so as to leave enough top space for holding bubbles generated by the vacuum. Use a mechanical mixing tool or hand tool to mix the resin and put mixed resin into resin supply container 560. All parts are connected as shown in FIG. 5.

(B4) Test leaking for the glass cavity and the system. Set valve 440 is in a “close” position, and valve 450 is in an “open” position. Turn 3-way valve 490 to a position to connect receiving container 470 and high-performance vacuum pump 591 and turn on the vacuum pump 591. If the vacuum and pressure meter 480 shows a level of vacuum close to the maximum vacuum level of the high-performance vacuum pump 591 and the vacuum level holds after turning off vacuum pump 591, it means that the system is well sealed and ready for filling the resin; otherwise, need to check and fix any leaking before repeating this step.

(B5) Conduct a vacuum liquid resin lamination. This process includes the following steps (a)-(d).

(a) System checking. Vacuum pump 591 is turned off. 3-Way valve 490 is at a position connecting receiving container 470 and vacuum pump 591 together. Make sure the lower end of long rigid tubing 531 is above clear container 520. Turn 3-way valve 590 to a closed position to resin supply container 560. Vacuum and pressure regulator 592 is adjusted to a low pressure such as 5 PSI. Turn valves 440 and 450 to an “open” position to allow all of the space in the VLRL system apparatus 500 to be connected.

(b) Resin degassing. Turn 3-way valve 590 to a position connecting resin supply container 560 to the atmosphere. Turn on the vacuum pump 591 to generate a vacuum to the VLRL system 500. Slowly close 3-way valve 490 to generate a low vacuum in the system 500 and allow degas to occur for the resin in clear container 520 while ensuring the resin bubble level is below the opening of clear container 520. Hold the low vacuum level for a few minutes to allow all of the remaining bubbles to rise to the top surface of the resin and burst to make a bubble-free resin at the bottom of the clear container 520. The purpose of this operation is not only for degassing at top of the resin, but also for removing, as much as possible, any bubbles at the bottom of the resin. Gradually increase vacuum by closing the 3-way valve 590 until a relatively high vacuum which is not necessarily the maximum vacuum level of the vacuum pump 591.

(c) Degassing for a first portion of resin, that is, resin initially entering the cavity 300. Push long rigid tubing 531 under the resin surface close to the bottom of clear container 520 (referring to a situation of 531A in FIG. 5) and now space in cavity 300 and space in resin supply container 560 are divided by the resin. After some resin enters into the bottom of cavity 300, close valve 440 and turn 3-way valve 590 to a position connecting resin supply container 560 to the atmosphere (through horizontal tubing). This operation allows a portion of resin to enter the cavity 300 to further degas under a high vacuum. Ensure 3-way valve 490 fully connects receiving container 470 to vacuum pump 591 to generate the highest vacuum in cavity 300.

(d) Filling resin. For average viscosity resins, the operational procedure is as follows: Slowly open valve 440 to allow clear resin to slowly enter into cavity 300 under a high vacuum until some resin is collected in receiving container 510. Close valve 450 and keep valve 440 open to allow resin in the cavity to get a balanced pressure. Turn vacuum pump 591 off and turn valve 440 to the closed position. Put pipe clamps in positions A and B and cut the hose between positions A and B. Put pipe clamps in positions C and D and cut the hose between positions C and D. Remove the filled panel from the system 500 for the curing process. Remove long rigid tube 531 and connect soft tubing 430 for one-time use. Due to the high vacuum, filled cavity 300 will be bubble free. The filling process can be done in a few minutes.

For any viscosity, especially a high viscosity, and for faster filling, the operational procedure is as follows: Slowly open valve 440 to allow the clear resin to enter into cavity 300 under a high vacuum. Turn 3-way valve 590 to connect resin supply container 560 and supply compressed air until some resin is collected in receiving container 510. Close valve 450 and keep valve 440 open to allow resin in the cavity to reach a balanced pressure. This operation will eliminate any vacuum spot or “vacuum bubble” with an additional pushing force from compressed air pressure. Turn off vacuum pump 591 and close valves 450 and 440. Put pipe clamps in positions A and B and cut the hose between positions A and B. Put pipe clamps in positions C and D and cut the hose between positions C and D. Remove the filled panel from system 500 for the next curing process. Remove long rigid tube 531 and connect soft tubing 430 for one time use. Due to the high vacuum, filled cavity 300 will be bubble free. The filling process can be completed in a few minutes. Of course, the system 500 can be also used for the single-part resin shown in system 400 and the manufacturing process can be even further simplified and faster.

(B6) Curing resin is similar to the procedure (A5) for system 400 described above. Depending on the type of resin used, the filled panel may be cured at room temperature with or without lighting or at an elevated temperature. For dual curing polymers that can be cured either by UV or by setting at room temperature, such as commercially available Uvekol A or Uvekol S (UV curable polyurethane type) or DayLightCure (acrylate type), the filled panel can be cured by setting it at room temperature. The working or gelling time can be adjusted from 1 hour to 3 hours depending on the amount of curing agent or catalyst added. After curing, the product, vacuum liquid resin laminated glass, is produced by detaching the adaptors 410 and 420 and/or tape 320 as described above.

In conventional methods, a vacuum force is used to draw resin up into the glass cavity. The degree of vacuum is relatively low, because a little vacuum power is enough to draw the liquid resin into the cavity. Furthermore, the cavity will contain a lot of air. There is no degassing function in the process, and there is no control when supplying resin to the cavity, thus no degassing function is applied without a controlled supply of resin, as bubbles may move with the resin. Due to various reasons, such as a change in localized differences of surface tension on the glass surface due to a dirty glass surface or unfavorable filling locations, such as corners of the cavity, any bubbles formed during the filling process are real air bubbles that are difficult to be removed. In contrast, a degassing function requires a relatively high vacuum and limited or no supply of resin to the cavity during degassing.

The method described herein, implements a high vacuum degassing process is implemented before and/or during the beginning of filling, in contrast to conventional methods. Specifically, in some embodiments, there are three degassing steps: first, the prefilled space of the cavity is vacuumed to remove air and test if it is sealed. Second, resin supply tank 560 is subjected to a vacuum to move any bubbles in the resin to the top portion of the container and degas it, at least making the bottom portion of the resin free of bubbles. Third, when the long rigid tube 531 is inserted into the bottom of the resin supply tank 560, the tubing 531 goes through the top portion of the resin which may contain some air bubbles, and the bubbles in the beginning of the tubing are degassed after the first portion of resin enters the cavity. After this point, most air in the prefilled cavity has been removed with a high vacuum, and keeping cavity 300 in a basically vertical position is not important. The resin used in the bottom of clear container 520 is also bubble free.

During the filling process, it is almost impossible to form bubbles even with many unfavorable conditions, for example, a change of surface tension of glass because of a dirty surface or unfavorable filling locations, such as corners of the cavity because of the lack of air in the prefilled cavity and the resin after these degassing treatments. The high vacuum degassing process before filling and at the beginning of filling effectively eliminates the possibility of the final product containing bubbles.

Compressed air is used mainly to speed up the filling rate and add a little more resin into the cavity for possible shrinkage of some resin formulas. It is essential to fill high viscosity resin by using compressed air. In conventional lamination methods, the driving force or pressure difference between the prefilled cavity and the pressure applied in the resin supply tank is gradually reduced during the filling process without a compressed air force and continuous vacuuming. The filling efficiency near the end is very low, because the driving force becomes weak.

In contrast, using compressed air in combination with the vacuum increases the maximum driving force, for example, up to 1.5 atm. (In this case, the pressure difference between the vacuum and the environment can contribute 1 atm, and an additional 0.5 atm pressure is contributed by the compressed air). The total filling efficiency is greatly improved in this arrangement, so that resins with high viscosities can be used in these embodiments.

Another advantage of the vacuum-pressure filling method is that it may prevent the formation of a vacuum spot for some formulas that have a high shrinkage rate. It does this by providing a little more resin in the cavity or a slightly thicker resin layer to compensate for shrinkage. Therefore, yield is improved.

As can be seen, the method described in this specification provides great freedom in selecting resins. For example, some acrylate resins have good UV stability but not very good adhesion to glass. However, a copolymer of acrylate and polyurethane may be used to improve the adhesion to glass. While selecting a copolymer of acrylate and polyurethane may generate a high viscosity resin, the use of compressed air and the resin degassing overcomes these problems. Adding coupling agent(s) into acrylate resins may also improve the adhesion of acrylate to glass, and the great freedom does not care about adding a liquid coupling agent or solid coupling agent into the original acrylate resin. The methods described in this specification may greatly enlarge the scopes of applications and reduce the required conditions of implements and increase the yield of productions.

As will be apparent to those skilled in the art, low viscosity resins may also be filled using compressed air. This will result in a very short filling time. Therefore, the final pressure needs to be well controlled to avoid applying too high a pressure that could result in a break in the filled glass panel.

Most paints contain pigment(s) and have viscosities around 100 cps (1 P, 0.1 Pa·s). Similarly, most resins with monomers and oligomers have viscosities less than 100 cps (1 P, 0.1 Pa·s). However, some resins have viscosities greater than 100 cps (1 P, 0.1 Pa·s). A resin with high viscosity will have a slower filling rate in making vacuum liquid resin laminated glass (VLRLG), but the filling rate can be accelerated by using air pressure, as described above. As shown in FIG. 5, turn the 3-way valve 590 to connect to a compressed air system such as an air compressor through a regulator 592. Since the cavity is formed with super high bond tape 310 or 320, added pressure should not be too high, otherwise, the edges of the cavity may split due to the high pressure. The pressure regulator 592 is for the safety of using compressed air. Depending on the protection of the edges, the air pressure used may be set at a low level on the regulator 592, such as 5 PSI or less, without strengthening the edges. Using clamps on the edges may strengthen them, allowing for higher pressure to be applied.

For high-speed filling, after inserting long rigid tubing 531 into the resin, turn 3-way valve 590 to connect the compressed air system and resin supply container 560. Since the resin is under a pressure difference, or vacuum in the cavity and pressure in resin supply container 560, the pressure difference increases the filling rate and/or allows for use of a resin with much higher viscosity. The pressure difference will also eliminate possible vacuum spots or “vacuum bubbles” in the cavity 300 during filling and avoid generating vacuum spots for some formulations with high shrinkages after curing. Since adding a low pressure can also cause a little higher thickness of resin layer 210 than a thickness determined by the spacers, the additional thickness may compensate for the material shrinkage, so as to avoid the generation of vacuum spots. Vacuum spots formed after curing usually are not round.

As described above, the example shown in FIG. 5 is suitable for handling multiple-part resin systems. It is also suitable for handling single-part resin systems, especially for resin systems with high viscosities.

Compared to interlayer lamination, the VLRL reduces costs by avoiding investment in large equipment, saving energy from using autoclaves or large ovens, and using low-cost liquid resin materials. The process is fast, improving operational efficiency by increasing yield, and product quality. VLRL technology provides superior interlayers with stronger adhesion, higher optical clarity and better performance, unprecedented adhesion, resistance to water and moisture, and over 99% UV blockage, as well as sound deadening properties, in addition to using non-flammable and odorless resin materials. Importantly, VLRL technology overcomes the limitations of conventional interlayer materials or thermoplastic polymers, which are not suitable for high temperature applications. The VLRL method may use all types of polymer systems and their combinations to meet higher and tougher standards and requirements. With the methods introduced in this disclosure, glass lamination is not limited to 5 m×5 m, and anyone can produce large laminated glass without heavy equipment.

Making a large VLRLG may reflect some advantages of VLRL technology with great freedom. Float glass production may produce very large sizes, but limitations of transportation, loading, unloading and storage typically result in float glass being cut to 3 m×6 m or smaller sizes. Finding an autoclave with a diameter equal to or greater than 4 m is very rare, therefore, it is difficult to produce a 5 m×5 m sized laminated glass by the interlayer lamination. It is also almost impossible to remove small air bubbles with a long needle syringe in 4 m×4 m polyurethane resin-filled glass cavity for cast lamination. In contrast, VLRL technology easily handles very large sizes with—a vacuum resin filling and curing with outdoor natural light or by setting outdoors under sunlight or in a shaded place for UV-curable or daylight curable resins. Resin sensitivities can be adjusted to fit the different brightness of natural light, such as direct sunlight or at a shaded place or to receive exposure from UV light, such as a medium-pressure mercury lamp. Curing with a catalyst(s) for some resins, such as silicone resin, is not dependent on lighting conditions.

The VLRL method provides a filling force (pressure difference) that is essential for the speed of lamination. Without such a filling force, it is practically impossible to use materials with relatively higher viscosities and/or multiple-part resin. It is also challenging to use high viscosity resin in cast lamination, as it is difficult for a glass cavity to naturally form a uniform thickness starting with an unevenly thick resin layer. Specifically, the panel does not have enough balancing force to flatten itself quickly for large sizes. Therefore, cast lamination can only use a few resins, such as UV curable polyurethane, and only within a limited range of viscosities because of no spacers used. Conversely, the VLRL method can use spacers to ensure the thickness and flatness of the panel and utilize vacuum force to ensure a high filling speed for resins with a wide range of viscosities, especially with the high vacuum increasing yield by efficiently removing air bubbles.

Another significant function of vacuum is degassing and it depends on controlling liquid resin supply. There is no degassing function for cases with an uncontrolled supply of resin. It should be understood that the degassing feature is a key function of the VLRL method and greatly expands the scope of usable resins, which in turn enlarges the scope of application. Most polymers, such as epoxy resin, polyester resin, polyimide resin, silicone resin, phenolic resin and polyethylene resin and many more, are formed with two or more parts and need to be mixed with all their components right before using the resin for polymerization. For simplicity, the resin's name may be called by the name of its polymer in the disclosure. Such resins usually have high viscosities. An efficient degassing feature is essential to utilize large groups of monomers, oligomers, resins, or pre-polymers, as discussed herein. This degassing feature allows the use of many liquid resins available in the market for making laminated glass, thereby greatly enhancing the performance of the final products. For example, silicone resin will improve heat resistance and polycarbonate resin will greatly improve UV resistance and polyimide resin will improve both heat resistance and UV resistance. The expanded scope of resin materials ensures wider and better performance of laminated glass products.

In this process, the spacers 220 are used to prevent two layers of glass 120 from touching each other, which would have slowed down the filling rate, make it difficult to remove air bubbles, and result in unqualified or uneven thickness. Spacers 220 may be made of plastic or glass. The shape of spacers may be spherical or cylindrical and the sizes of spacers 220 may be between 5 microns and 200 microns or larger. When spacers 220 are smaller than 100 microns or are transparent plastic, spacers 220 are invisible in cured resin 210 and an ultra-clear cured interlayer can be formed. Using spacers makes the control of the VLRL process easier and faster. In case where the spacers are not desired or are not available in appropriate sizes, the VLRL process can also produce the products. If keeping prefilled cavity 300 in vertical position during filling, no spacers are needed even for making large sized VLRL panels. However, curing should be down in a horizontal position, like curing position in cast lamination (no spacers used in cast lamination), or in a vertical position.

Laminated glass is needed in many applications for better durability and safety, especially in public areas such as stores, malls, and airports. Laminated glass was invented over a century ago and interlayer lamination has been used for a long time using thermoplastic polymers. Cast lamination may use a few non-thermoplastic polymers but it has limitations. For example, polymers formed from two or more parts cannot be used and air bubbles formed in the filled resin cannot quickly and easily removed. Vacuum liquid resin lamination, as described in the disclosure, has many advantages over interlayer lamination and cast lamination for making laminated glass. These advantages include a new feature of degassing, which greatly enlarges the scope of applicable polymers including polymers formed from two or more parts. The VLRL in the production of laminated glass is new, because the new feature and function of degassing during filling are well suited to the thickness of the interlayer for common laminated glass, and the new method can surprisingly handle viscosities of 100 cps (1 P, 0.1-Pa·s) which is a range of viscosity covering most paints and higher viscosity polymers. Smaller viscosities are easier for the VLRL process, because removing air bubbles by vacuum is easier. Therefore, the new method of VLRL greatly enlarges the scope of applicable polymers resulting in laminated glass with many extended new features and high performances. It is very convenient to observe the polymerization of a liquid resin that can be cured at room temperature or by daylight or UV-A (long wave UV without generating ozone). Such liquid resins may have adjustable viscosity to fit different filling mechanisms, designed toughness to fit different applications, and strong adhesion to handle varied application conditions. The method introduced in the disclosure provides the flexibility to meet these higher standards and challenges while supporting an enlarged scope of applicable materials.

The manufacturing process of vacuum liquid resin laminated glass (VLRLG), such as the apparatus 200 has a significant advantage in terms of energy consumption compared to conventional interlayer laminated glass manufacturing processes, such as the apparatus 100. The manufacturing process for apparatus 200 can be conducted at room temperature, whereas the interlayer lamination process must be conducted at high temperature and high pressure, requiring large equipment such as a large autoclave or vacuum oven. VLRL is the most economical production method to produce better quality and/or larger sizes of laminated glass with a much wider selection of polymers or copolymers.

There is also a saving on materials used in the apparatus 200 in comparison with the apparatus 100, as the apparatus 200 avoids using expensive interlayer materials. Liquid resins used in the apparatus 200 are usually monomers or oligomers that are starting materials for producing interlayer materials. The cost of liquid resin is only a fraction of the cost of interlayer materials used in autoclave lamination.

Omitting the thermoplastic interlayer used in autoclave lamination also eliminates optical distortion and some level of haze, which are common with thermoplastic interlayers. Interlayer lamination creates some polarization in laminated glass, because the thermoplastic interlayer material is stretched when in semi-solid state. Laminated glass with polarization is not qualified to be used as an optical device such as a projection panel, because common laser projectors with polarized lights may show all kinds of defective patterns. Wearing polarized sunglasses can also reveal all kinds of optic defects, such as in laminated glass car windows.

The VLRL process used to make the apparatus 200 is more efficient than the classic interlayer lamination used to make apparatus 100. Interlayer lamination has special requirements on the thickness of glass to ensure uniformity of heating. The thickness in interlayer lamination must be neither too thick nor too thin. In contrast, the VLRL used to form apparatus 200 permits greater variations in the thickness of the glass, ranging from inches in thickness to paper-thin glass.

When comparing production efficiency, the VLRL process has a much higher efficiency than the interlayer lamination process using an autoclave. In the autoclave process, it takes several hours to vacuum the air from an airbag containing multi-layers of different materials. Removing air from multiple very fine gaps between the glass and interlayer takes a long time, and any contamination of air will cause defects on the final laminated glass with shining air bubbles. A slow heating process is required to keep the temperature uniform on the materials in the autoclave to avoid glass deformation. A slow cooling process is required to avoid glass breaking. Lamination with a vacuum oven has similar inefficiencies, except no additional pressure is applied to the airbag. These requirements result in a low efficiency in the overall process of interlayer lamination, usually requiring an entire shift to finish one process cycle. In contrast, the new VLRLG structure of apparatus 200 simplifies the production process and greatly increases efficiency. Processes to make VLRLG as in apparatus 200 may be completed in less than one hour by one person or a small group of people. The VLRL process is also suitable for production with an automated mass production line. Since the VLRL process does not require heavy equipment and special materials, it can be as simple as the assembly of prefabricated components. Production of VLRLG can be also conducted by a single person or at customer job sites. An existing single layer of window glass may be converted into a VLRLG panel at the customer's site.

Preventing delamination is crucial in the production of laminated glass as any delaminated area is visually apparent, particularly when the glass is used for buildings and automobiles, which require longtime and outdoor applications. Uneven bottom edges of two glass pieces may delamination due to the shearing force generated between them. Delamination may occur on old automobile windows. Such risks usually do not exist for the vacuum liquid resin laminated products, because the adhesion of the cured resin to glass (paint adhesion, a chemical adhesion) is usually much stronger than the adhesion of interlayer (tape adhesion, a physical adhesion), because interlayer is only partially melted during heat lamination in the autoclave and plasticizer contained in the interlayer affects good adhesion. Adhesion in VLRL is fully on the molecular level, in which material molecules chemically provide much stronger chemical bonding than physical adhesion. Due to different coefficients of thermal expansion and contraction between glass and polymer, coupling agent(s) may be added to the liquid resin to improve the bonding strength between glass and the polymer formed from the resin. A coupling agent is a chemical that enhances adhesion between different materials. The costs of producing and using the apparatus 200 are, therefore, reduced in comparison to the apparatus 100. Advantages of VLRL include low-cost materials and energy savings, less material usage, simple equipment, simple process, less manpower needed, and high efficiency of production. The cost of producing VLRLG is easily half that of the cost of interlayer laminated glass or cast laminated glass. Such new methods and new materials may support more new applications and may be more suitable for popularizing the use of laminated glass.

Apparatus 200 combines the advantages of durability, ease of use and production, well-protected formation in glass format, low production cost, and no requirement for large production equipment. A single person can produce VLRLG at a very low cost without the need for large equipment. This process is also suitable for creating hurricane-proof glass or hurricane-proof safety glass or bulletproof glass. VLRLG may be used for any existing application for laminated glass made by interlayer process or cast lamination process, but also for high performance applications like bulletproof laminated glass with fewer layers or less weight and high efficiency soundproof laminated glass and laminated glass for use in high temperature. The interlayer cured with liquid resin may be easily designed with special properties in density, elasticity and stability according to the application's requirements or computational optimization.

In some applications of VLRLG, such as a glass curtain wall, safety may be a concern. All types of architectural safety glasses, including reinforced, toughened and laminated glasses, may be used as glass 120 in apparatus 200. Glass 120 may be in more durable forms such as tempered glass, hurricane-proof glass or bulletproof glass to enhance strength and safety. Any transparent panel with special features such as safety, double-layer or self-cleaning may be used in the apparatus 200. More specifically, VLRLG 200 may be formed with two or more layers of silica-based glass or a combination of silica-based glass and polymer-based panels. Different layers may have the same materials of glass or different materials of glass. Bulletproof glass is one kind of laminated glass, with a strength capable of stopping a bullet. VLRLG 200 may be formed by curing with UV or daylight or natural light or catalyst or a thermo-curing process. Catalysts include photo-initiator 1173 for acrylic resin, MEK peroxide for polyester resin, and triethylenediamine for polyurethane. These methods not only provide high strength, but also have much lower costs.

One of the major benefits of VLRLG 200 is its safety feature. Throughout this specification, “glass” refers to both silica-based and organic-based glass. Upon impact, the glass fragments adhere to the interlayer, significantly reducing the risk of serious injury. This feature depends on two key material properties: the adhesion to glass and the strength of the interlayer itself. VLRL has several advantages over interlayer lamination or cast lamination, with respect to these two key properties.

First, an interlayer has limited mobility because it is a solid of thermoplastic polymer, and contains a plasticizer for reducing lamination temperature. During lamination, it becomes semi-melted and has limited adhesion (mainly physical adhesion). In contrast, liquid resin normally contains monomers or oligomers with greater mobility as a liquid for full molecular contact with the surface of the glass, resulting in much higher adhesion (mainly chemical adhesion or bonding) in comparison to solid polymers. This is similar to two different types of adhesion between chemical bonding/adhesion for paints and physical adhesion for tapes. Additionally, it is efficient to improve adhesion by adding adhesion promoters, such as silanes, which are small coupling molecules that react at a molecular level.

Secondly, in order to have its bonding function, an interlayer cannot have a high level of cross-links, otherwise, it cannot melt at the raised temperature in autoclave lamination. Although plasticizers are added to reduce lamination temperature, the interlayer still cannot have a high level of cross-links, because plasticizers cannot soften highly polymerized or highly cross-linked materials. A low level of cross-link greatly limits the interlayer's strength, requiring an additional layer of plastic, such as a polycarbonate layer, to absorb the impact energy for bulletproof glass. In VLRL, any level of cross-link can be designed and implemented in cured resin to increase or adjust the strength of the resin. A level of cross-link may be easily designed with a ratio of different functional groups or amount of catalysts. Therefore, an interlayer formed from the liquid resin may have three improved functions: the adhesion function for combining two glass panels, the function of bearing and absorbing impact energy, and UV protection.

Since VLRL can easily handle viscosities of 100 cps, the liquid resin basically can utilize most paint-like polymers without pigment(s). The liquid resin can also have a transparent color like a stain to make a color laminated glass. Such color laminated glass has much lower costs than colored glass. With these advantages, bulletproof glass panels or hurricane-proof glass panels made by liquid resin lamination may have fewer layers or be thinner and lighter, thereby lowing their costs. VLRLG can also have different colors to match the building's color for a better appearance.

VLRL provides methods for producing a wide range of products. The properties of liquid resin and its polymer can be easily modified to meet specific requirements and purposes. For instance, different molecular weights of the same chemicals, such as monomers and oligomers, can be used to adjust the viscosity and level of crosslink. Different viscosities may be better suited for different applications and improve production efficiency.

VLRLG can be designed to completely block UV radiation by adding UV stable and UV absorbing aromatic components such as a bisphenol A group, or adding a UV absorber(s). Adding an UV stabilizing agent(s) or UV absorber(s) into a liquid resin is a way to improve the UV stability of the polymer in a VLRLG for outdoor applications. The liquid resin can be also designed to be partially or completely UV transparent, selectively allowing UVA and/or UVB to pass for plants to grow, or for humans to produce vitamin D, by using aliphatic and aromatic monomers or oligomers.

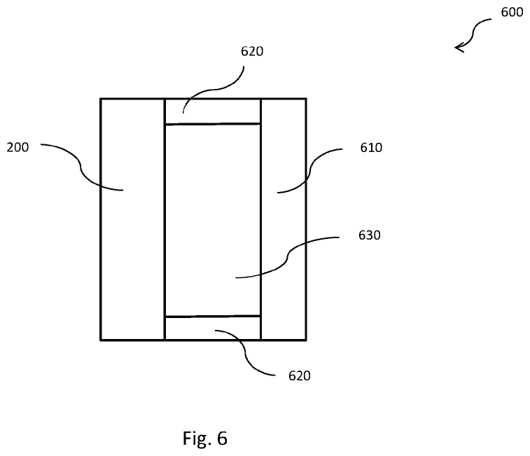

Similar to conventional laminated glass with an interlayer, vacuum liquid resin laminated glass (VLRLG) also possesses safety and energy-saving features. VLRLG can be used as building glass. Referring FIG. 6, a VLRLG may be also used to make a laminated insulating glass unit (IGU) 600 for building use. A laminated IGU 600 consists of one or more layers of glass, such as a third layer of glass 610, separated by a space or gap 630 and a sealing spacer 620 at all edges between VLRLG 200 and the third layer of glass 610 to reduce heat transfer across building envelope. The gap 630 may be filled with air or an inert gas, or be a vacuum. VLRLG or laminated IGU may be formed with annealed glass or tempered glass. Due to poor flatness of tempered glass, traditional interlayer lamination of tempered glass usually cannot be made into laminated glass but this is not the case with VLRLG, as discussed above. By adding dyes or pigments to resin, the color of the liquid resin can be easily changed, allowing for the creation of colored VLRLG or colored laminated IGU to match the desired colors of building windows.

Typically, bulletproof glass requires multiple layers, often more than five layers with a thickness of about 2 inches. A conventional sequential lamination is normally used to make bulletproof glass, adding one or two layers at a time until the desired number of layers is achieved. However, this process is time-consuming, energy-intensive, and costly. The VLRL process offers a cost-effective alternative by simultaneously filling and laminating multilayers to lower cost or filling up different resins in separated layers to improve impact resistance with fewer layers. Additionally, VLRL can be conducted at room temperature without the need for heavy equipment, saving energy and reducing costs. This makes liquid resin laminated bulletproof glass or hurricane-proof glass more affordable than similar products made using interlayer lamination or cast lamination.

One of the advantages of VLRL is its ability to laminate tempered glass. Tempered glass is typically not flat and bent tempered glass has less parallelism, making them difficult to laminate with an interlayer. However, VLRL may easily handle variations in flatness and parallelism due to its liquid mobility.

The glass used in the apparatus 200 may be made of various materials including silicone-based glass and polymer-based glass, such as acrylic and polycarbonate. Plastic panels, often called plastic glass, can be used in interlayer lamination. VLRLG with plastic materials offers advantages such as lightweight and bendability. Interlayer lamination with plastic layers requires special interlayers suitable for a lower lamination temperature. However, many interlayer materials cannot be used for plastic lamination in an autoclave due to the risk of permanent deformation of the plastic layers or panels. This risk is avoided with VLRLG since it can be made using a room-temperature curing process.

The apparatus 200 may have inserts in the layer of polymer 210, such as, specimen leaves, pictures or plastic sheets for decoration or other purposes. The inserts can be made of a wide variety of materials, such as natural carbohydrates, paper, or plastic sheets, and may occupy part or the entire area of the resin layer 210.

Although the present disclosure has been described with respect to specific details, it is not intended that such details should be regarded as limitations on the scope of the disclosure, except to the extent that they are included in the accompanying claims.

What is claimed is:

1. A liquid resin laminated glass panel, comprising:
a first layer of glass;
a second layer of glass; and
a layer of polymer that is polymerized or cured from a liquid resin while in contact with the first layer of glass and the second layer of glass;
wherein the liquid resin is added into a substantially sealed glass cavity formed between the first layer of glass and the second layer of glass by a vacuum.

2. The liquid resin laminated glass panel of claim 1, wherein the liquid resin is added into the substantially sealed glass cavity with a degassing.

3. The liquid resin laminated glass panel of claim 1, wherein the polymer is formed from a one-part resin or a multiple-part resin.

4. The liquid resin laminated glass panel of claim 1, wherein the polymer or the liquid resin comprises spacers.

5. The liquid resin laminated glass panel of claim 1, wherein the polymer comprises one or more of: a polyacrylate, a polyurethane, a polycarbonate, a polysilicon, a polyester, an epoxy, a polysulfide, a polyimide, a polyphenolic, a polyethylene, or a copolymer.

6. The liquid resin laminated glass panel of claim 1, wherein a spacing between the first layer of glass and the second glass layer is 0.01 to 2.00 millimeters.

7. The liquid resin laminated glass panel of claim 1, wherein the liquid resin further comprises one or more of: a dye, a pigment, a coupling agent, or a UV absorber.

8. The liquid resin laminated glass panel of claim 1, wherein at least one of the first glass layer or the second glass layer comprises a low-e coating.

9. The liquid resin laminated glass panel of claim 1, wherein the polymer comprises one or more inserts of natural carbohydrate, paper, picture, or plastic sheet.

10. The liquid resin laminated glass panel of claim 1, wherein the panel is fitted to a third layer of glass positioned on the panel such that the third layer of glass is separated from the panel with a sealing spacer positioned at edges thereof, thereby defining a gap between the panel and the third layer of glass to form a laminated insulating glass unit.

11. The liquid resin laminated glass panel of claim 10, wherein the gap is filled with air or an inert gas, or is a vacuum.

12. A method for making a liquid resin laminated glass panel, comprising:
providing a glass cavity, wherein the glass cavity comprises a first layer of glass and a second layer of glass, the glass cavity being substantially sealed at edges;
placing a liquid resin between the first layer of glass and the second layer of glass; and
curing the liquid resin to form the panel;
wherein the liquid resin is added into the glass cavity by a vacuum and subsequently cured to bond to the first layer of glass and the second layer of glass.

13. The method of claim 12, wherein the glass cavity is sealed with tape.

14. The method of claim 12, wherein the first layer of glass and the second layer of glass are separated by spacers when being bonded.

15. The method of claim 12, further comprising creating an opening on the edges of the glass cavity and attaching an adaptor attached to the opening to allow air or the liquid resin to enter or leave the glass cavity.

16. The method of claim 12, wherein before or during filling the glass cavity with the liquid resin, the liquid resin is degassed.

17. The method of claim 12, wherein the liquid resin is cured by exposing the liquid resin to daylight, ultraviolet light or heat.

18. The method of claim 12, wherein placing the liquid resin comprising a use of compressed air to increase a filling rate and/or prevent formation of vacuum spot(s).

19. The method of claim 12, wherein the panel is fitted to a third layer of glass positioned on the panel such that the third layer of glass is separated from the panel with a sealing spacer positioned at edges thereof, thereby defining a gap between the panel and the third layer of glass.

20. A system for making a liquid resin laminated glass panel, comprising:
a glass cavity substantially sealed at edges configured to be filled with a liquid resin under a vacuum;
an adaptor attached to the glass cavity to transfer the liquid resin and/or air into or out of the glass cavity;
a vacuum pump for degassing the liquid resin and/or filling the liquid resin into the glass cavity;
a container to hold the liquid resin for filling up the glass cavity or to collect the liquid resin from the glass cavity; and
a valve connecting the adaptor and the container to control the liquid resin and/or air passing through.
